(19) United States
(12) Patent Application Publication
(10) Pub. No.: US 2012/0236339 A1
(43) Pub. Date: Sep. 20, 2012

(54) MANAGEMENT APPARATUS, MANAGEMENT SYSTEM, MANAGEMENT METHOD, AND STORAGE MEDIUM

(75) Inventor: Jin Sunata, Yokohama-shi (JP)

(73) Assignee: CANON KABUSHIKI KAISHA, Tokyo (JP)

(21) Appl. No.: 13/397,364

(22) Filed: Feb. 15, 2012

(30) Foreign Application Priority Data
Mar. 18, 2011 (JP) 2011-060795

(51) Int. Cl. G06K 15/16; G06K 15/02

(52) U.S. Cl. 358/1.12; 358/1.14

(57) ABSTRACT

A management apparatus manages a plurality of image forming apparatuses as a connected unit, and receives failure information regarding failure that has been occurred from any one of the plurality of image forming apparatuses included in the connected unit. The management apparatus generates notification information indicating addressing processing for the failure occurred in the plurality of image forming apparatuses included in the connected unit based on the positional relationship among the plurality of image forming apparatuses and the type of the failure indicated by the received failure information, and notifies the generated notification information.

### BACKGROUND OF THE INVENTION

1. Field of the Invention

The present invention relates to a technique for managing an image forming apparatus.

2. Description of the Related Art

A method for addressing an occurred error or jam by a user or a service person when a failure (e.g., error or jam) occurs in an image forming apparatus has been proposed. For example, Japanese Patent Laid-Open No. 2009-208300 discloses an image forming apparatus that automatically generates a test job in order to reduce a recovery confirmation operation during system maintenance by a service person. At the time of maintenance of a normal jam, the image forming apparatus performs the specification of the location where the jam has occurred, a jam reproduction test, and a test for confirming that the cause for a jam has been eliminated after the completion of maintenance so as not to occur a jam again. In other words, the image forming apparatus stores execution job attribute information at the time of occurrence of a jam, and generates a test job in which a print setting is set based on the type of a jam and attribute information about a job stored in correspondence with the job to thereby reduce the number of steps of maintenance test.

Also, Japanese Patent Laid-Open No. 2008-287501 discloses a monitoring system that groups a plurality of image forming apparatuses to be monitored to thereby determine the urgency of maintenance on a group basis instead of an apparatus basis. Even when the same error occurs in different groups, the monitoring system determines the importance degree of error on a group basis, and thus, varies the importance degree of error depending on each group. For example, the monitoring system determines that the urgency of performing maintenance when an error occurs in two devices at an office where there are only three devices is higher than that when an error occurs in three devices at an office where there are a hundred devices.

Although a test to be executed by the image forming apparatus disclosed in Japanese Patent Laid-Open No. 2009-208300 must be performed using a print setting for a paper sheet to pass through a location where a jam has occurred in order to confirm whether a jam is reproduced or is not reproduced, a service person needs to be familiar with the print setting for a paper sheet to pass through a location where a jam has occurred. Furthermore, a service person must performs a print setting operation each time a test is performed, and then, execute a job. In addition, the image forming apparatus does not generate a test job for a paper sheet to pass through a location where a jam has occurred in consideration of the cause of occurrence of a jam or an addressing method. Depending on the type of the image forming apparatus, all of the locations where a jam has occurred are recorded for testing, and thus, all of the locations where a jam has occurred are to be subject for maintenance. Therefore, as the number of locations for maintenance increases in the case of an image forming apparatus or a large machinery having many sheet transfer paths, maintenance may be very time-consuming.

Also, the monitoring method performed by the monitoring system disclosed in Japanese Patent Laid-Open No. 2008-287501 monitors a plurality of image forming apparatuses by grouping them, but does not address a failure in response to the cause of the failure for each image forming apparatus in a group.

### SUMMARY OF THE INVENTION

The management apparatus of the present invention manages a plurality of image forming apparatuses as a unit of execution for print processing, and notifies an addressing method suitable for a failure in response to the cause of the failure for each image forming apparatus occurred in a unit of execution for print processing.

According to am aspect of the present invention, a management apparatus is provided that includes an association unit configured to associate and manage a plurality of image forming apparatuses as a unit of execution for print processing; a reception unit configured to receive first failure information regarding failure occurred in a first image forming apparatuses among the plurality of image forming apparatuses included as a unit of execution of the print processing via a network; a generation unit configured to generate notification information indicating addressing processing for the failure occurred in the plurality of image forming apparatuses included as a unit of execution of the print processing based on the positional relationship among the plurality of image forming apparatuses and types of the failures indicated by the received first failure information and second failure information when the second failure information has been received from a second image forming apparatuses among the plurality of image forming apparatuses included as a unit of execution of the print processing; and a notification unit configured to notify the generated notification information.

Further features of the present invention will become apparent from the following description of exemplary embodiments with reference to the attached drawings.

### BRIEF DESCRIPTION OF THE DRAWINGS

FIG. 1 is a diagram illustrating an example of the system configuration of the present embodiment.

FIG. 2A is a diagram illustrating an example of the hardware configuration of an image forming apparatus.

FIG. 2B is a diagram illustrating an example of the hardware configuration of a management apparatus.

FIG. 3 is a functional block diagram illustrating an exemplary image forming apparatus.

FIG. 4 is a functional block diagram illustrating an exemplary management apparatus.

FIG. 5 is a diagram illustrating an example of cooperative utilization of image forming apparatuses.

FIG. 6A is a diagram illustrating an example of the connection monitor setting screen.

FIG. 6B is a diagram illustrating an example of the failure addressing information registration screen.

FIG. 7 is a diagram illustrating an example of failure addressing information.

FIG. 8 is a flowchart illustrating an example of operation processing performed by a management apparatus.

FIG. 9A is a diagram illustrating an example of failure information.

FIG. 9B is a diagram illustrating an example of notification information.

FIG. 10A and FIG. 10B are diagrams illustrating an example of the failure information collection result.

### DESCRIPTION OF THE EMBODIMENTS

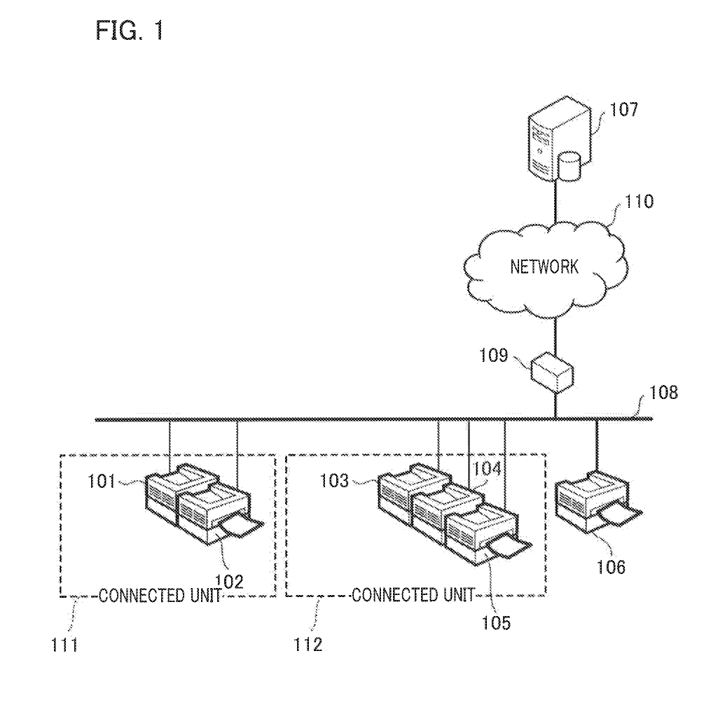

FIG. 1 is a diagram illustrating an example of the system configuration of the present embodiment. A management system (hereinafter referred to as “management system”) of the image forming apparatus shown in FIG. 1 includes image forming apparatuses 101 to 106 that execute print processing, and a management apparatus 107 that manages the image forming apparatuses 101 to 106. A method for managing the image forming apparatus of the present embodiment is realised by the management system. Each image forming apparatus and the management apparatus 107 are allowed for communication via LAN (Local Area Network) 108, a network device 109, and a network 110. The network device 109 is, for example, a proxy or a firewall. The network 110 is, for example, LAN, a private line such as a fixed telephone line or a mobile phone line, Internet, or the like.

The image forming apparatuses have the same configuration. Examples of the image forming apparatus include a digital multifunction peripheral, a facsimile, a laser beam printer, an inkjet printer, and a scanner. The image forming apparatuses may be physically connected to each other for cooperative utilization depending on the type thereof. The management apparatus 107 associates and manages a plurality of image forming apparatuses, which can be physically connected to each other for cooperative utilisation, as a unit of execution for print processing. The term “cooperative utilization” refers to the state in which a plurality of image forming apparatuses is physically connected to each other in terms of a sheet transfer system and an electrical device system to process a print job cooperatively by a plurality of image forming apparatuses. Hereinafter, a unit of execution for print processing including a plurality of image forming apparatuses for cooperative utilization is described as a “connected unit”. In the example shown in FIG. 1, the image forming apparatuses 101 and 102 are managed as a connected unit 111. Also, the image forming apparatuses 103, 104, and 105 are managed as a connected unit 112. The image forming apparatus 106 is utilized alone.

Each image forming apparatus may notify the status of itself to the management apparatus 107 via the network 110. For example, each of the image forming apparatuses notifies an occurred error or paper jam (jam) to the management apparatus 107. Regardless of the fact that the image forming apparatuses are utilised in a cooperative manner or in an independent manner, each image forming apparatus independently notifies the status of itself to the management apparatus 107.

The management apparatus 107 is, for example, a server, a PC (Personal Computer), or the like. The management apparatus 107 manages a plurality of image forming apparatuses as a connected unit, and notifies an addressing method suitable for a failure in response to the cause of the failure for each image forming apparatus occurred in a connected unit.

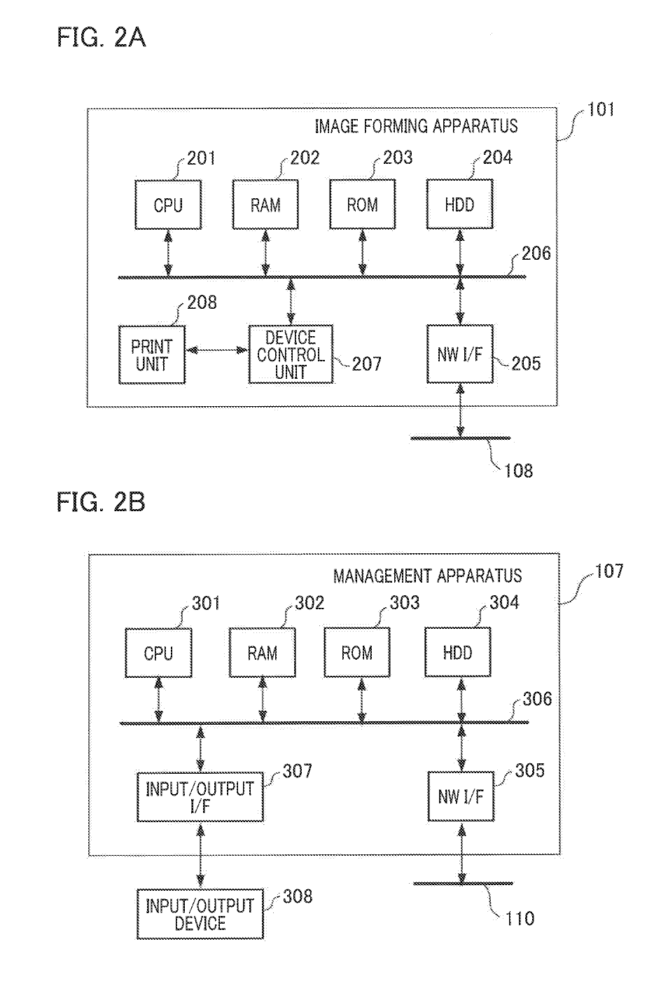

FIG. 2A and FIG. 2B are diagrams illustrating an example of the hardware configuration of an image forming apparatus and a management apparatus, respectively. FIG. 2A shows an example of the hardware configuration of the image forming apparatus 101. The image forming apparatus 101 includes a CPU 201, a RAM 202, a ROM 203, an HDD 204, an NW I/F 205, a device control unit 207, and a print unit 208, where CPU is an abbreviation for Central Processing Unit, RAM is an abbreviation for Random Access Memory, ROM is an abbreviation for Read Only Memory, HDD is an abbreviation for Hard Disk Drive, and NW I/F is an abbreviation for Network Interface.

The CPU 201 executes a program stored in the ROM 203. The CPU 201 generally controls the image forming apparatus 101 overall via an internal bus 206. For example, the CPU 201 performs processing for recording image data onto a recording medium such as the HDD 204 or the like.

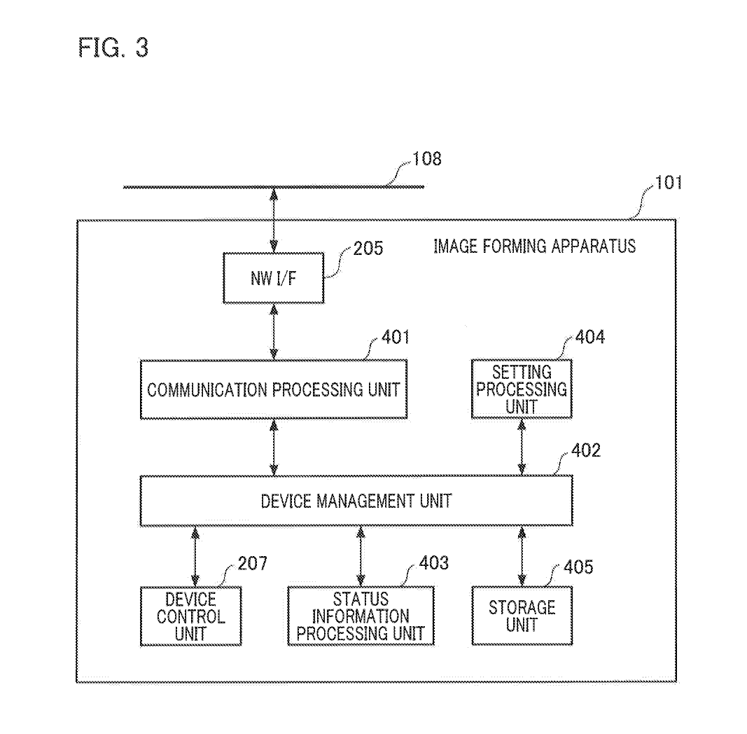

The RAM 202 functions as a memory or a work area for the CPU 201. The ROM 203 stores a program for realizing the function of the image forming apparatus 101 (for example, a program for realizing the processing units shown in FIG. 3 to be described below) in advance. The HDD 204 functions as an external storage device, stores image data or the like as well as stores counter information, system information, and status information provided in the image forming apparatus 101.

Counter information is information about the counter indicating the number of sheets in use in print processing, the component counter indicating the usage status of a component, and the function counter indicating other usage statuses. System information is information about the system of the image forming apparatus 101. Status information is information indicating the status of the image forming apparatus 101. Status information includes, for example, information indicating the execution state of a job and failure information. Failure information is information indicating that a jam or error has occurred in the image forming apparatus 101. Failure information includes, for example, a hard error such as an excessive rise in temperature of the print unit 208 or internal communication cut-off, an error such as paper jam, no toner, door open, overloaded paper discharge tray, or the like.

The device control unit 207 controls the print unit 208 that performs image forming processing. The device control unit 207 controls the print unit 203 and may acquire status information from a sensor provided in the print unit 208. Status information indicates the status of the image forming apparatus 101. The CPU 201 notifies the acquired status information to the management apparatus 107 via the NW I/F 205, LAN, and the network 110.

FIG. 2B is a diagram illustrating an example of the hardware configuration of a management apparatus. The management apparatus 107 includes a CPU 301, a RAM 302, a ROM 303, an HDD 304, an NW I/F 305, and an input/output I/F 307.

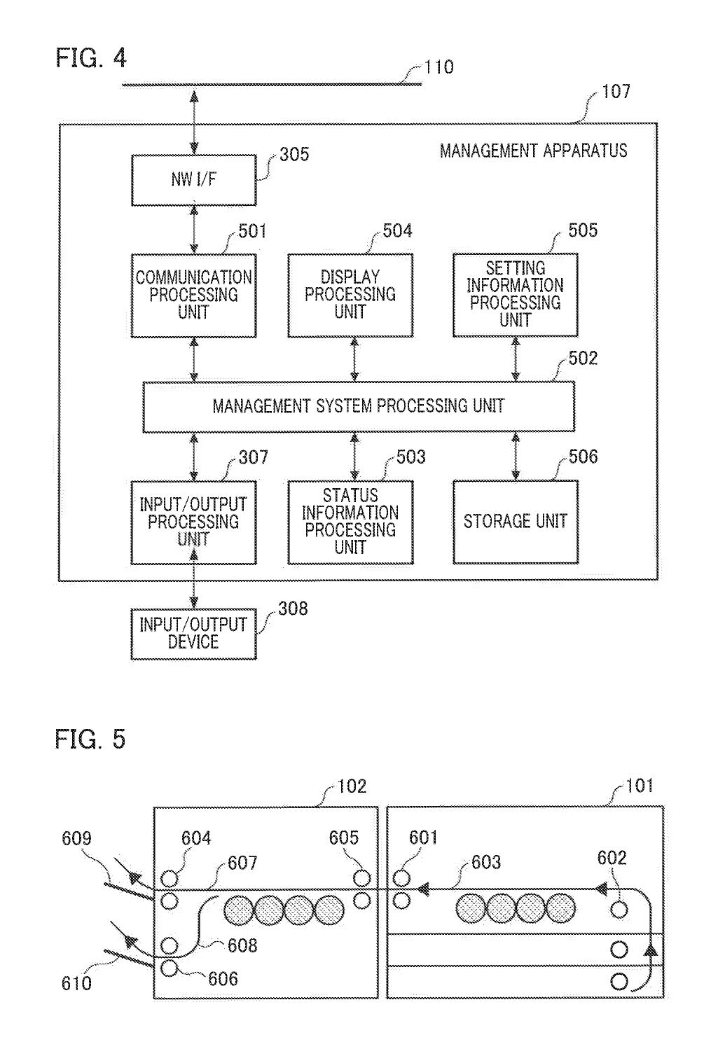

The CPU 301 executes a program stored in the ROM 303. The CPU 301 generally controls the management apparatus 107 overall via an internal bus 306. The RAM 202 functions as a memory or a work area for the CPU 201. The ROM 203 stores a program for realizing the function of the management apparatus (for example, a program for realising the processing units shown in FIG. 4 to be described below) in advance. The HDD 304 functions as an external storage device, and stores registration information regarding the image forming apparatus. The HDD 304 also stores counter information, system information, and status information received from the image forming apparatus 101. The HDD 304 further stores image data.

The input/output I/F 307 is an interface that accepts input information for performing the setting and management of the management apparatus 107. An input/output device 308 inputs input information to the management apparatus 107 via the input/output I/F 307. The input/output device 308 is, for example, a display, a keyboard, a mouse, or the like. The UI function for inputting input information is provided to a user by the input/output device 308 and the input/output I/F 307.

The CPU 301 may also provide the UI function to an external device via the network 110. For example, the CPU 301 may also provide the UI function for executing the setting and management of the management apparatus 107 from an external device using a protocol such as HTTP (HyperText Transfer Protocol) or the like. Also, the CPU 301 may transmit print data generated by a predetermined processing unit (not shown) to the image forming apparatus or the connected unit via the network 110 to thereby cause it to perform print processing for the print data.

FIG. 3 is a functional block diagram illustrating an exemplary image forming apparatus. The image forming apparatus 101 shown in FIG. 3 includes an NW I/F 205, a device control unit 207, a communication processing unit 401, a device management unit 402, a status information processing unit 403, a setting processing unit 404, and a storage unit 405. The NW I/F 205 is the same as the I/F 205 shown in FIG. 20. The device control unit 207 is the same as the device control unit 207 shown in FIG. 2A. The storage unit 405 is any one of the RAM 202, the ROM 203, and the HDD 204 shown in FIG. 2A.

The image forming apparatus 101 is connected to a LAN 108 via the NW I/F 205. The NW I/F 205 exchanges required information with the management apparatus 107 in accordance with the instruction given by the communication processing unit 401 and the device management unit 402.

The communication processing unit 401 includes the function of processing communication protocol. The communication processing unit 401 transmits the status of the image forming apparatus 101 to the management apparatus 107 using a predetermined communication protocol. Also, the communication processing unit 401 receives information (e.g., print data) transmitted from the management apparatus 107. The communication protocol is, for example, the SNMP (Simple Network Management Protocol) or the SOAP (Simple Object Access Protocol).

The device management unit 402 manages and controls the operation of the image forming apparatus 101 overall. The device management unit 402 is connected to the communication processing unit 401, the device control unit 207, the status information processing unit 403, the setting processing unit 404, and the storage unit 405.

The device management unit 402 receives print data received by the communication processing unit 401, and performs print processing for the print data. Also, the device management unit 402 receives data read by the print unit 208 via the device control unit 207, and performs processing (e.g., image forming processing) for the received data.

The device control unit 207 acquires counter information, system information, and status information about the image forming apparatus 101. The device control unit 207 stores the acquired counter information, system information, and status information in the storage unit 405. The device control unit 207 may also be adapted to acquire the operation status of the device or the operation status of the device at the occurrence of a failure as part of status information.

The status information processing unit 403 reads status information stored in the storage unit 405, and converts the status information into information to be notified to the management apparatus 107. The status information processing unit 403 performs processing for converting failure information included in status information acquired at the time of occurrence of a paper jam into information about the type of a failure, a time of occurrence of a failure, and the model of the image forming apparatus, and information for specifying the location where a failure hens occurred (e.g., information about a transfer roller at which a failure has occurred). The device management unit 402 transmits the converted status information to the management apparatus 107 via the communication processing unit 401.

The device management unit 402 may also transmit not only information acquired by the device control unit 207 but also information acquired by the communication processing unit 401 and the setting processing unit 404 as communication data to the management apparatus 107. When the device management unit 402 transmits the communication data to the management apparatus 107, the device management unit 402 also transmits information specific to the image forming apparatus or setting information (IP address, MAC address, device serial number, product name, product type, or the like) to the management apparatus 107. With this arrangement, the management apparatus 107 may perform individual processing for each image forming apparatus.

The setting processing unit 404 sets and changes setting information required for the operation of the image forming apparatus 101, and makes a notification setting to the management apparatus 107. Also, the setting processing unit 404 makes a setting regarding cooperative utilization of the image forming apparatus 101, i.e., a setting regarding a connected unit.

FIG. 4 is a functional block diagram illustrating an exemplary management apparatus. The management apparatus 107 shown in FIG. 4 includes an NW I/F 305, an input/output processing unit 307, a communication processing unit 501, a management system processing unit 502, a status information processing unit 503, a display processing unit 504, a setting information processing unit 505, and a storage unit 406. A method for controlling the management apparatus of the present embodiment and the computer program of the present embodiment are realized by the functions of the processing units provided in the management apparatus 107.

The NW I/F 305 is the same as the NW I/F 305 shown in FIG. 2B. The input/output processing unit 307 is the same as the input/output processing unit 307 shown in FIG. 2B. The storage unit 506 is any one of the RAM 302, the ROM 303, and the HDD 304 shown in FIG. 2B.

The communication processing unit 501 is connected to the network 110 via the NW I/F 305. The communication processing unit 501 exchanges information with the image forming apparatus 101 to be managed via the network 110 in accordance with the instruction given by the management system processing unit 502. The communication processing unit 501 includes the function of processing communication protocol. Since the communication processing unit 501 receives and processes a notification from the image forming apparatus 101, the communication processing unit 501 may provide communication using a protocol such as SMTP or HTTP prepared by the image forming apparatus.

As operation processing specific to the present embodiment, the communication processing unit 501 functions as a reception unit that receives failure information regarding failure that has been occurred from any one of a plurality of image forming apparatuses included in a connected unit via a network.

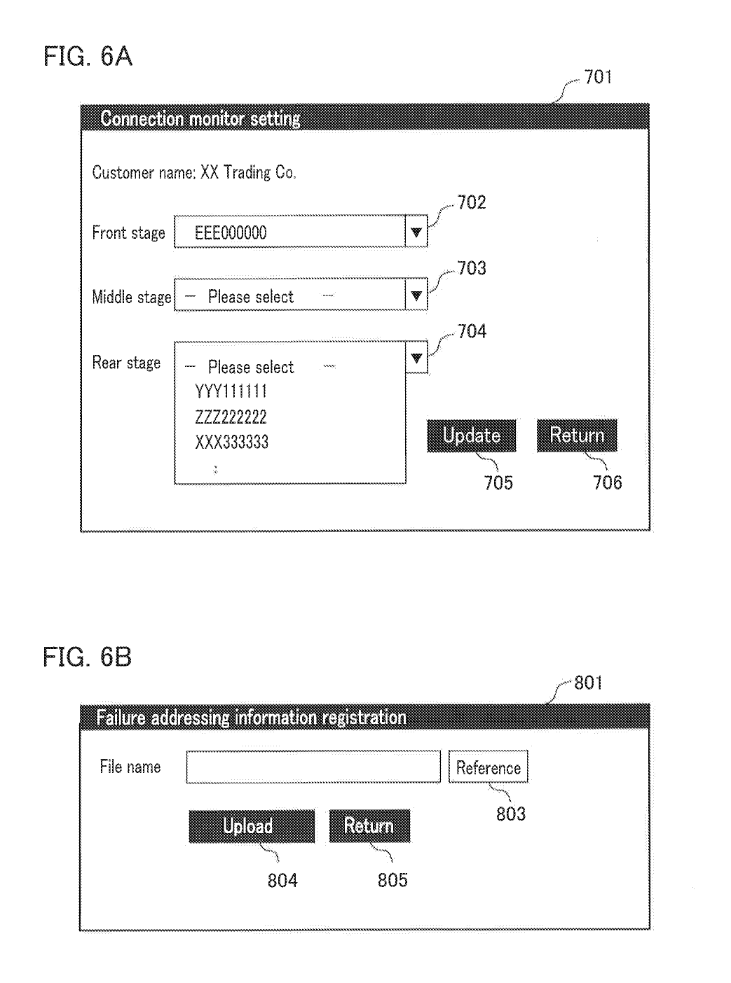

The management system processing unit 502 controls the management apparatus 107 overall. As operation processing specific to the present embodiment, the management system processing unit 502 functions as an association unit that associates and manages a plurality of image forming apparatuses as a connected unit. The management system processing unit 502 associates and manages a plurality of image forming apparatuses as a connected unit in accordance with the setting content on a connection monitor setting screen to be described below with reference to FIG. 6A.

Also, the management system processing unit 502 functions as a generation unit that generates notification information indicating addressing processing for the failure occurred in a plurality of image forming apparatuses included in a connected unit. The management system processing unit 502 generates the notification information based on the positional relationship among the plurality of image forming apparatuses and the type of the failure indicated by the received failure information when failure information has been received from each of the plurality of image forming apparatuses included in a connected unit. The management system processing unit 502 instructs the input/output processing unit 307 to cause the input/output device 308 to display the generated notification information, and thus, addressing processing is notified to a user.

The status information processing unit 503 manages status information that has been received from the image forming apparatus by the communication processing unit 501. The management system processing unit 502 determines addressing processing corresponding to the failure using failure information included in the status information.

The display processing unit 504 generates information about a user interface through which the setting of the management apparatus 107 is made from an information processing device (not shown) connected via the communication processing unit 501. The display processing unit 504 generates a screen where display and update of the setting may be made using, for example, HTML (HyperText Markup Language), and transmits the generated screen to the information processing device via the communication processing unit 501. The setting information processing unit 505 uses an input/output device 308 such as a display, a keyboard, or a mouse via the management system processing unit 502 and the input/output processing unit 307 to register and update setting information or to display the setting status. Setting information is, for example, a setting regarding operation processing performed by the management system processing unit 502 and the status information processing unit 503. The storage unit 506 stores failure addressing information in advance.

FIG. 5 is a diagram illustrating an example of cooperative utilization of image forming apparatuses. In FIG. 5, a description will be given taking an example of a case where the image forming apparatus 101 (a first image forming apparatus) and the image forming apparatus 102 (a second image forming apparatus) are included in one connected unit. In the example shown in FIG. 5, the image forming apparatus 101 is a front stage, and the image forming apparatus 102 is a rear stage. The front stage is an image forming apparatus that firstly starts print processing. The rear stage is an image forming apparatus that finally starts print processing. In other words, the image forming apparatus 101 firstly performs print processing, and passes a printed matter to the image forming apparatus 102 that is physically connected to the image forming apparatus 101. The image forming apparatus 102 executes print processing for the printed matter passed from the image forming apparatus 101. For example, the image forming apparatus 101 performs normal print processing, and the image forming apparatus 102 performs transparent printing for the printed matter that is the output result of the print processing to thereby output glossy printed matter.

As an example of cooperative utilization, the printing system of the image forming apparatus 102 may be changed from an electrophotographic printing system to an ink-jet printing system such that only a photo data part is output by the image forming apparatus 102 with an ink-jet printing system.

The image forming apparatus 101 includes transfer rollers 601 and 602 that transfer paper sheets during printing. Each transfer roller includes a sensor that detects a paper jam or an operation failure. The sensor may detect whether or not any problem has occurred on paper transfer on a path 603 through which a paper sheet is transferred. When the sensor detects an operation failure such as paper jam or the like, the image forming apparatus 101 notifies status information including failure information to the management apparatus 107.

When the image forming apparatus 101 successfully performs print processing, a printed matter is passed to a transfer roller 605 that is a paper insertion unit of the image forming apparatus 102. The image forming apparatus 102 transfers a printed matter received by the transfer roller 605 by means of the sheet transfer path 607 or 608 to continue processing. The sheet transfer path for outputting a printed matter to a sheet discharge port 609 is the path 607. The sheet transfer path for outputting a printed matter to a sheet discharge port 610 is the path 608. A printed matter is discharged to the sheet discharge port 609 via a transfer roller 604. Also, a printed matter is discharged to the sheet discharge port 610 via a transfer roller 606.

Each of the transfer rollers 605, 604, and 606 includes a sensor that detects paper jam or operation failure. When a sensor detects operation failure such as paper jam or the like, the image forming apparatus 102 notifies status information including failure information to the management apparatus 107. The number of image forming apparatuses included in a connected unit may be three or greater.

FIGS. 6A and 6B are diagrams illustrating examples of the connection monitor setting screen and the failure addressing information registration screen. FIG. 6A is a diagram illustrating an example of the connection monitor setting screen. A connection monitor setting screen 701 is a user interface for setting a connected unit. For example, the display processing unit 504 of the management apparatus 107 provides a connection monitor setting screen to an external information processing device to cause it to display the connection monitor setting screen, and a user of the information processing device sets a connected unit on the connection monitor setting screen. The management system processing unit 502 receives the setting content of the connected unit via the communication processing unit 501, and associates and manages a plurality of image forming apparatuses included in the connected unit in accordance with the setting content. With this arrangement, the positional relationship between the connected unit and the plurality of the image forming apparatuses included in the connected unit.

For collectively managing a plurality of image forming apparatuses that are linked to each other, the connection monitor setting screen 701 includes list boxes 702, 703, and 704 for specifying an image forming apparatus to be managed. Each list box may specify a linking order or an arrangement state. A front-stage image forming apparatus which firstly starts processing may be specified by the list box 702. A middle-stage image forming apparatus which receives the printed matter processed at the front stage and subsequently performs processing may be specified by the list box 703. A rear-stage image forming apparatus which finally processes the printed matter may be specified by the list box 704. A plurality of image forming apparatuses specified by the list boxes is managed as a connected unit in a manner different from stand alone management.

A user may update the specified information using an update button 705. The setting content made by the specifying operation on the connection monitor setting screen 701 is stored in the storage unit 506 provided in the management apparatus 107. After the update of the specified information or when the specified information is not reflected, the connection monitor setting screen 701 is transitioned to another screen by depressing a return button 706. When two image forming apparatuses are cooperatively utilized, a middle-stage image forming apparatus needs not be specified.

FIG. 6B is a diagram illustrating an example of the failure addressing information registration screen. The failure addressing information registration screen is a user interface for registering failure addressing information. On the failure addressing information registration screen shown in FIG. 6B, a user may register failure addressing information indicating addressing processing depending on a failure occurred in the connected unit specified on the connection monitor setting screen shown in FIG. 6A. For example, the display processing unit 504 of the management apparatus 107 provides the failure addressing information registration screen to an external information processing device to cause it to display the failure addressing information registration screen, and a user of the information processing device inputs failure addressing information on the failure addressing information registration screen. The management system processing unit 502 receives the input failure addressing information via the communication processing unit 501, and stores the input failure addressing information in the storage unit 506.

The failure addressing information registration screen 801 has an input field 802 in which the data file of failure addressing information is specifiable, and a reference button 803 in which a file is selectable. The failure addressing information data file specified by a user is uploaded onto the management apparatus 107 by depressing an upload button 804. When a user exits the failure addressing information registration screen 801, the failure addressing information registration screen 801 is transitioned to another screen by depressing a return button 805.

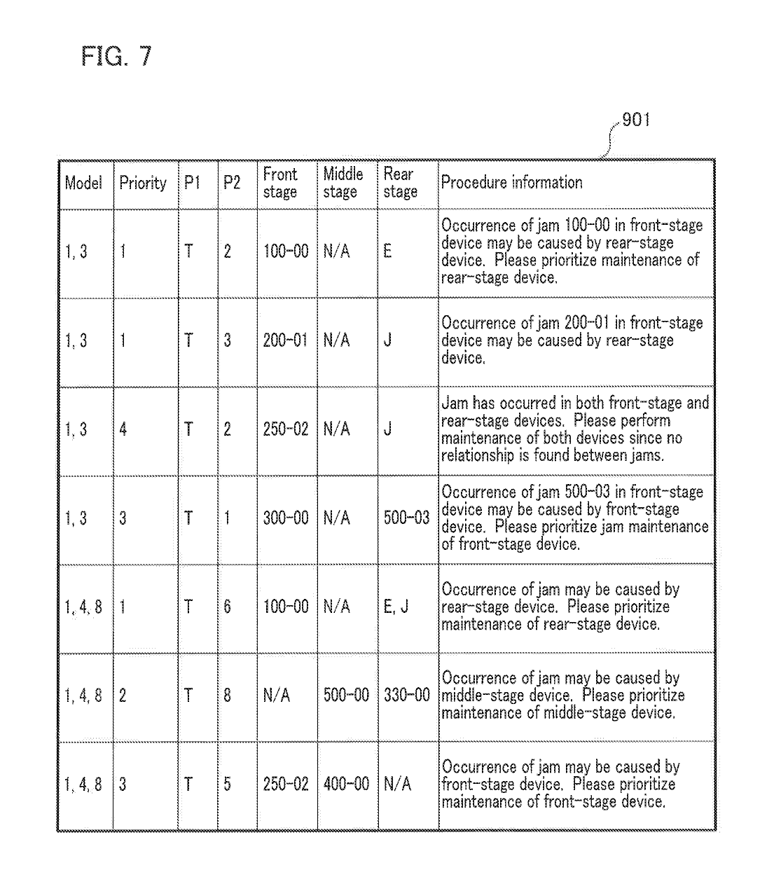

FIG. 7 is a diagram illustrating an example of failure addressing information. Failure addressing information is stored in the storage unit 506 in the table format shown in FIG. 7. The data file format of failure addressing information may be CSV (Comma Separated Values) format or XML (Extensible Markup Language) format.

Failure addressing information 301 shown in FIG. 7 includes data items such as model, priority, P1, P2, front stage, middle stage, rear stage, and procedure information. The item “model” indicates a combination of the models of the image forming apparatuses included in a connected unit to be managed. For example, the item “model” included in the first entry (one line data) of the failure addressing information 901 indicates that a model 1 and a model 3 are included in a connected unit. The sequence of the models set in the item “model” indicates the positional relationship among the models. For example, since the models 1 and 3 are set in the “model” included in the first entry in the order from the left, the model 1 is the front stage and the model 3 is the rear stage. For example, since the models 1, 4, and 8 are set in the “model” included in the sixth entry in the order from the left, the model 2 is the front stage, the model 4 is the middle stage, and the model 8 is the rear stage.

The item “priority” indicates an image forming apparatus that is the cause of the occurrence of a failure. The number “1” set in the item “priority” indicates that the rear-stage image forming apparatus is the cause of the occurrence of a failure. The number “2” indicates that the middle-stage image forming apparatus is the cause of the occurrence of a failure. The number “3” indicates that the front-stage image forming apparatus is the cause of the occurrence of a failure. The number “4” indicates that the cause of a failure cannot be clearly specified. When the number “4” is set in the item “priority”, the maintenance of all the image forming apparatuses in which a failure has occurred is to be notified.

A value set in the item “priority” is determined depending on the positional relationship of the image forming apparatus in which a failure has occurred and the type of the failure. For example, a predetermined value is set in the item “priority”. Each time a failure occurs in a connected unit, the management system processing unit 502 may determine which image forming apparatus is the cause of the failure depending on the positional relationship of the image forming apparatus in which the failure has occurred and the type of the failure so as to set a value depending on the determination result in the item “priority”.

Values set in the items “P1” and “P2” indicate transmission interval information. Transmission interval information indicates a reference value (reference interval) for the time interval during which the device has transmitted failure information received from the image forming apparatus. When the transmission time interval indicated by failure information from a plurality of image forming apparatuses is within the reference value, the management system processing unit 502 determines addressing processing corresponding to the failure indicated by failure information, the details of which will be described below.

More specifically, the item “P1” indicates time. The item “P2” indicates second. For example, the symbol “T” is set in the item “P1” of the first entry and the number “2” is set in the item “P2” of the same. For example, when the time interval between the time at which the management apparatus 107 has received failure information from the model 1 and the time at which the management apparatus 107 has received failure information from the model 3 is within two seconds, the management system processing unit 502 determines failure addressing processing set in procedure information included in the first entry as the subject to be notified.

The item “front stage” indicates a failure corresponding to failure information to be transmitted from the front-stage model included in the connected unit. For example, the number “100-00” set in the item “front stage” of the first entry indicates jam 100-00 that occurs in the front-stage image forming apparatus (the model 1). The symbol “E” set in the item “rear stage” indicates any error that occurs in the rear-stage image forming apparatus (the model 3). Note that the connected unit corresponding to the first entry does not include the middle-stage image forming apparatus. Thus, the symbol “N/A” set in the item “middle stage” indicates no information.

For example, the symbol “J” set in the item “rear stage” of the third entry indicates any jam that occurs in the rear-stage image forming apparatus (the model 3). The item “procedure information” indicates addressing processing corresponding to the failure occurred in the connected unit corresponding to the entry. Addressing processing may be preset in the item “procedure information”. Alternatively, the management system processing unit 502 may determine addressing processing each time a failure occurs in the connected unit so as to set the determined addressing processing in the item “procedure information”.

Assume the case where, in the connected unit including the model 1 and the model 3, an error occurs in the rear-stage model 3, and then, the jam 100-00 occurs in the front-stage model 1. In this case, among the entries in the failure addressing information 901, the management system processing unit 502 selects the first entry in which 100-00 is set in the item “front stage” and error is set in the item “rear stage”.

The management system processing unit 502 determines whether or not the failure information transmission interval from the model 3 and the model 1 is within the time interval (two seconds) indicated by the item “P1” and “P2” included in the selected first entry. When the failure information transmission interval from the model 3 and the model 1 is within two seconds, the management system processing unit 502 sets addressing processing set in the item “procedure information” included in the first entry as the subject to be notified. When the management system processing unit 502 has determined that the failure information transmission interval from the model 3 and the model 1 is not within two seconds, the management system processing unit 502 sets the maintenance of both front-stage and rear-stage image forming apparatuses as the subject to be notified.

A description will be given taking an example in which the management system processing unit 502 determines addressing processing each time a failure occurs in a connected unit and sets addressing processing in the item “procedure information” so as to notify addressing processing. In the aforementioned example, the number “1” is set in the item “priority” of the first entry. The number “1” set in the item “priority” means that another failure has occurred in the front-stage image forming apparatus due to the cause made by the rear-stage image forming apparatus. Thus, the management system processing unit 502 sets the description, in which the occurrence of the jam 100-00 in the front-stage image forming apparatus may be caused by the rear-stage image forming apparatus and the maintenance of the rear-stage image forming apparatus is prioritised, in the item “procedure information”. Also, the management system processing unit 502 notifies the set description content.

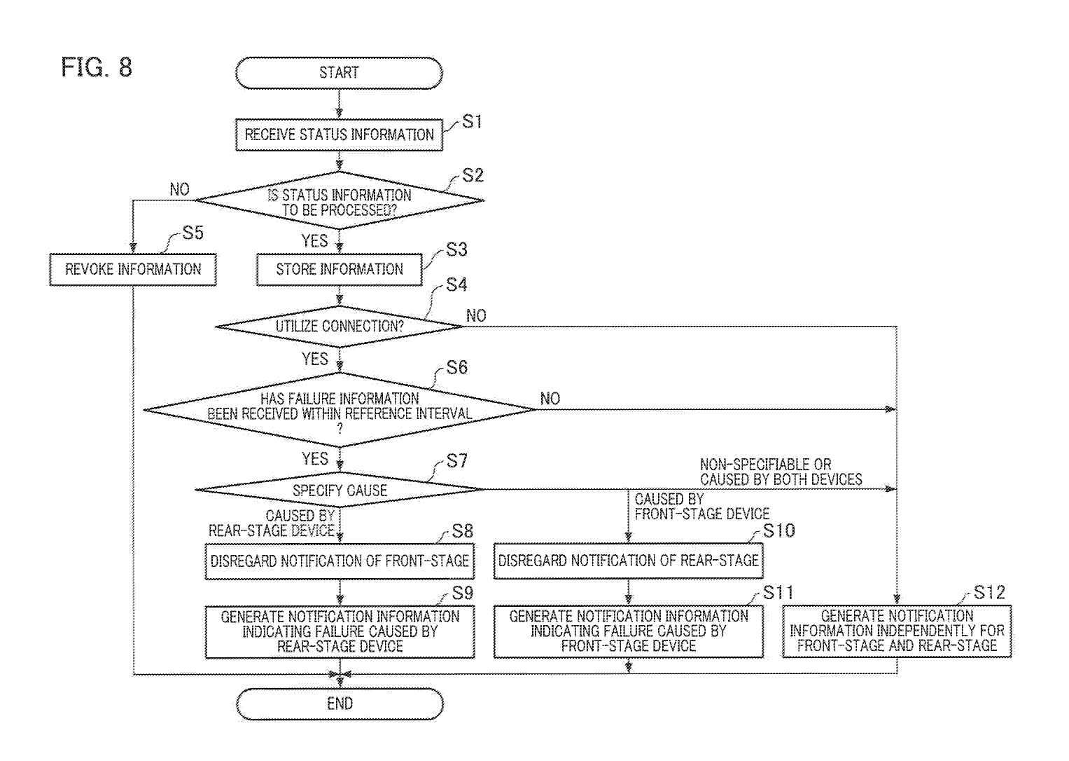

FIG. 8 is a flowchart illustrating an example of operation processing performed, by a management apparatus. It is assumed that the image forming apparatuses 101 and 102 are managed as a connected unit. First, the management system processing unit 502 receives status information from one of the image forming apparatuses 101 and 102 (step S1). Next, the management system processing unit 502 determines whether or not the received status information is information to be processed (step S2). More specifically, when status information includes failure information, the management system processing unit 502 determines that status information is information to be processed. When status information does not include failure information, the management system processing unit 502 determines that status information is not information to be processed.

When the management system processing unit 502 has determined that the received status information is not information to be processed, the management system processing unit 502 revokes status information (step S5), and the process is ended. When the management system processing unit 502 has determined that the received status information is information to be processed, the management system processing unit 502 stores status information in the storage unit 506 (step S3). Status information stored in the storage unit 506 in step S3 includes failure information. Failure information includes information about the type of a failure, a time of occurrence of the failure, and the model of the image forming apparatus in which the failure has occurred.

Next, the management system processing unit 502 determines whether or not the image forming apparatus is included in the connected unit to be managed, that is, the image forming apparatus is an image forming apparatus to be cooperatively utilized, based on information about the model of the image forming apparatus included in failure information and information about the connected unit under management (step S4). When the image forming apparatus is not an image forming apparatus to be cooperatively utilized, the process advances to step S12. Then, the management system processing unit 502 generates failure addressing information for each image forming apparatus which is the transmission source of status information including failure information (step S12), and the process is ended. When the image forming apparatus is an image forming apparatus to be cooperatively utilized, the process advances to step S6.

In step S6, the management system processing unit 502 determines whether or not failure information from another image forming apparatus included in the connected unit has been received within the reference interval from the transmission time based on the failure information transmission time received in step S1 (step S6). In other words, the management system processing unit 502 functions as a determination unit that determines whether or not the transmission time interval of failure information received from each of a plurality of image forming apparatuses included in a connected unit is within a predetermined reference interval. More specifically, in step S6, the management system processing unit 502 first determines that failure information has been received from another image forming apparatus included in at connected unit. When failure information has not been received, the process advances to step S12. When failure information has been received from another image forming apparatus, the management system processing unit 502 refers to the failure addressing information 901 and executes the following processing. The management system processing unit 502 selects an entry corresponding to the connected unit, the positional relationship among a plurality of image forming apparatuses included in the connected unit under management, and the type of a failure included in failure information. Then, the management system processing unit 502 acquires the reference interval indicated by the items “P1” and “P2” included in the selected entry, and determines whether or not failure information has been received from another image forming apparatus included in the connected unit within the reference interval. When the management system processing unit 502 has not received failure information from another image forming apparatus within the reference interval, the process advances to step S12. When the management system processing unit 502 has received failure information from another image forming apparatus within the reference interval, the process advances to step S7.

A specific description will be given taking an example of processing in step S6. For example, when an error occurs in the image forming apparatus 102 as shown in FIG. 5, a transfer system is stopped. Consequently, the transfer roller 604 detects a jam, and thus, the paper transfer in the sheet transfer path 607 is stopped. When a printed matter, which is being subsequently printed, is present in the image forming apparatus 101, the sheet transfer path 603 is also stopped, and thus, a jam is detected by the transfer roller 601 or 602.

The image forming apparatus 102 notifies information about an error occurred during driving of the transfer roller as failure information (first failure information) to the management apparatus 107. The image forming apparatus 101 notifies information about a jam detected by the transfer roller 601 or 602 as failure information (second failure information) to the management apparatus 107. The management apparatus 107 manages the notified failure information.

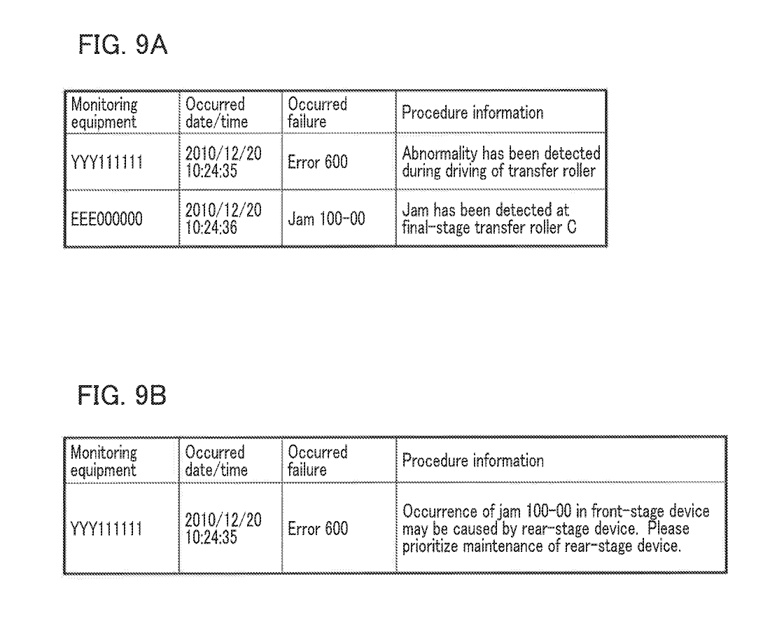

FIG. 9A is a diagram illustrating an example of failure information managed by the management apparatus 107. Failure information includes data items such as monitoring equipment, occurred date/time, occurred failure, and procedure information. Monitoring equipment indicates an image forming apparatus which is the transmission source of failure information. Occurred date/time indicates a time when failure information was transmitted by an image forming apparatus. Occurred failure indicates the type of a failure indicated by failure information. Procedure information indicates the result of detection of the failure. The first entry of failure information shown in FIG. 9A is failure information received from the image forming apparatus 102 by the management apparatus 107. Also, the second entry is failure information received from the image forming apparatus 101 by the management apparatus 107.

Here, it is assumed that the image forming apparatus 101 is the model 1 at the front stage and the image forming apparatus 102 is the model 3 at the rear stage. The management system processing unit 502 selects the first entry among the entries of failure addressing information shown in FIG. 7. The reference interval indicated by the items “P1” and “P2” included in the selected entry is two seconds. Referring to failure information shown in FIG. 9A, a time from when the image forming apparatus 102 transmits failure information until the image forming apparatus 101 transmits failure information is one second. Thus, in step S6 shown in FIG. 8, the management system processing unit 502 determines that failure information has been received from another image forming apparatus within the reference interval.

Next, the management system processing unit 502 specifies an image forming apparatus, which is the cause of the occurrence of a failure, in the connected unit (step S7). The management system processing unit 502 determines whether or not an image forming apparatus which is the cause of the occurrence of a failure is a front stage or a rear stage based on the number set in the item “priority” included in the entry corresponding to the failure. For example, since the number “1” is set in the item “priority” of the first entry of the failure addressing information 901 shown in FIG. 7, the management system processing unit 502 determines that an image forming apparatus which is the cause of the occurrence of a failure is a rear stage.

The management system processing unit 502 may specify an image forming apparatus which is the cause of the occurrence of a failure based on the positional relationship of the image forming apparatus in which the failure has occurred and the type of the failure. For example, based on failure information shown in FIG. 9A, the management system processing unit 502 determines that a jam occurred in the front-stage image forming apparatus 101 is caused by the occurrence of an error in the rear-stage image forming apparatus 102. With this arrangement, an image forming apparatus which is the cause of the occurrence of the failure may be specified depending on the content of the occurred failure.

When an image forming apparatus which is the cause of the occurrence of a failure may not be specified in the connected unit or when all the image forming apparatuses included in the connected unit (in this example, front stage and rear stage) are the cause of the occurrence of a failure, the process advances to step S12.

When the management system processing unit 502 has specified the rear-stage image forming apparatus as the image forming apparatus, which is the cause of the occurrence of a failure, in the connected unit, the management system processing unit 502 executes the following processing. The management system processing unit 502 set addressing processing corresponding to the failure occurred in the front-stage image forming apparatus as the subject not to be notified (step S8). Then, the management system processing unit 502 sets information indicating that addressing processing corresponding to the failure occurred in the rear-stage image forming apparatus is prioritized as notification information (step S9). In other words, when it has been determined that the failure information transmission time interval is within the reference interval, the management system processing unit 502 generates notification information including information indicating that which one of a plurality of image forming apparatuses included in a connected unit is prioritized for addressing processing. This is because the failures occurred in a plurality of image forming apparatuses included in a connected unit may be connected to each other when the failure information transmission time interval is within the reference interval. FIG. 9B shows an example of notification information.

When the management system processing unit 502 has specified the front-stage image forming apparatus as the image forming apparatus, which is the cause of the occurrence of a failure, in the connected unit, the management system processing unit 502 executes the following processing. The management system processing unit 502 set addressing processing corresponding to the failure occurred in the rear-stage image forming apparatus as the subject not to be notified (step S10). Then, the management system processing unit 502 sets information indicating that addressing processing corresponding to the failure occurred in the front-stage image forming apparatus is prioritised as notification information (step S11).

As described with reference to FIG. 3, the management system processing unit 502 executes the following processing when the failure information transmission time interval is not within the reference interval. The management system processing unit 502 generates notification information including information indicating predetermined addressing processing corresponding to the failure occurred in each of a plurality of image forming apparatuses (in this embodiment, the first image forming apparatus and the second image forming apparatus) included in a. connected unit (No in step S6, step S12).

Also, when the failure information transmission interval is within the reference interval, the management system processing unit 502 specifies an image forming apparatus which is the cause of the occurrence of a failure depending on the positional relationship among a plurality of image forming apparatuses in which the failure has occurred and the type of the failure indicated by failure information (step S7). Then, no management system processing unit 502 generates information indicating that the execution of addressing processing corresponding to the failure occurred in the specified image forming apparatus is prioritized as notification information (steps S9 and S11). Here, the generated notification information is notified to the PC terminal, for a personal who prepares the maintenance of an image forming apparatus or the PC terminal for the administrator of the image forming apparatus.

The management apparatus of the present embodiment may manage a plurality of image forming apparatuses as a unit of execution for print processing so as to notify an addressing method suitable for a failure in response to the cause of the failure for each image forming apparatus occurred in a unit of execution for print processing.

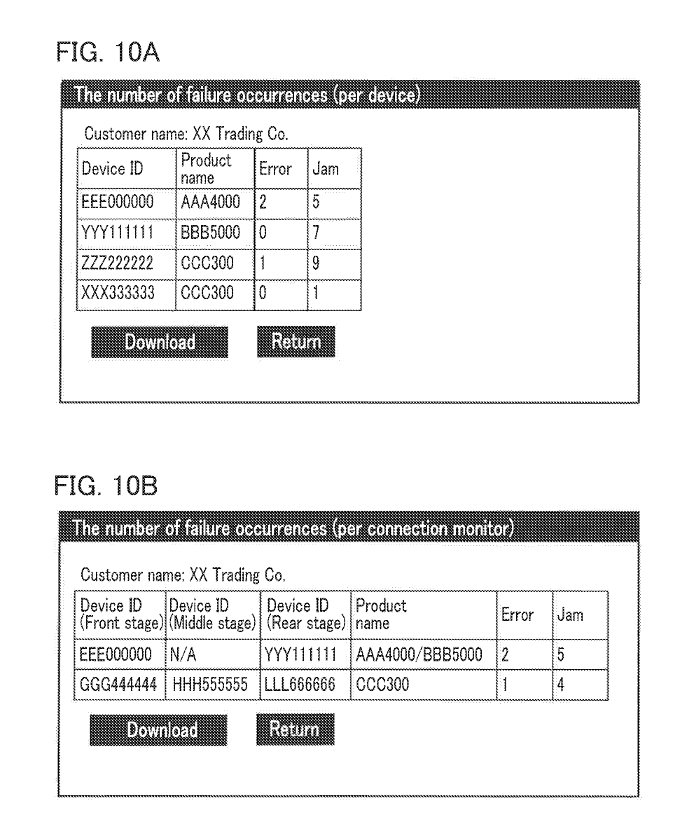

FIGS. 10A and 10B are diagrams illustrating an example of the failure information collection result. FIG. 10A shows the result of collection of the number of failure occurrences for each device (image forming apparatus). The management system processing unit 502 collects the number of failure occurrences for each device based on failure information, and displays the collected result shown in, for example, FIG. 10A. A user can acquire the collected result in the text file by depressing the download button.

FIG. 10B shows the result of collection of the number of failure occurrences for each connected unit. The management system processing unit 502 collects the number of failure occurrences for each connected unit based on failure information, and displays the collected result shown in, for example, FIG. 10B. A user can acquire the collected result in the text file by depressing the download button.

Note that a connected unit to be managed by the management apparatus 107 may include any print processing device other than an linage forming apparatus. For example, a connected unit may also include a finisher with a function capable of detecting and notifying an error occurred during print processing. A connected unit may also include a paper transfer device that mechanically brings a plurality of image forming apparatuses into connection or a device that performs coating on an output sheet. A failure occurred in each of the devices included in a connected unit may be notified to the management apparatus 107 via external monitoring equipment.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-060795 filed Mar. 18, 2011, which is hereby incorporated by reference herein in its entirety.

What is claimed is:

1. A management apparatus comprising:
an association unit configured to associate and manage a plurality of image forming apparatuses as a unit of execution for print processing;
a reception unit configured to receive first failure information regarding failure occurred in a first image forming apparatuses among the plurality of image forming apparatuses included as a unit of execution of the print processing via a network;
a generation unit configured to generate notification information indicating addressing processing for the failure occurred in the plurality of image forming apparatuses included as a unit of execution of the print processing based on the positional relationship among the plurality of image forming apparatuses and types of the failures indicated by the received first failure information and second failure information when the second failure information has been received from one or more second image forming apparatuses among the plurality of image forming apparatuses included as a unit of execution of the print processing; and
a notification unit configured to notify the generated notification information.

2. The management apparatus according to claim 1, further comprising:
a determination unit configured to determine whether or not the interval of a transmission time of the first failure information and the second failure information is within a predetermined reference interval,
wherein the generation unit generates notification information including information indicating that which one of the plurality of image forming apparatuses included as a unit of execution of the print processing is to be preferentially addressed when it has been determined by the determination unit that the interval of the transmission time of the first failure information and the second failure information is within the reference interval.

3. The management apparatus according to claim 2, wherein, when is has been determined by the determination unit that the interval of the transmission time of the first failure information and the second failure information is not within the reference interval, the generation unit generates notification information including information indicating predetermined addressing processing depending on the first failure information and the second failure information respectively.

4. The management apparatus according to claim 1, wherein the first failure information or the second failure information indicates that a jam has occurred.

5. A control method for managing an image forming apparatus,
associating and managing a plurality or image forming apparatuses as a unit of execution for print processing;
receiving first failure information regarding failure occurred in a first image forming apparatuses among any one of the plurality of image forming apparatuses included as a unit of execution of the print processing via a network;
generating notification information indicating addressing processing for the failure occurred in the plurality of image forming apparatuses included as a unit of execution of the print processing based on the positional relationship among the plurality of image forming apparatuses and types of the failures indicated by the received first failure information and second failure information when the second failure information has been received from one or more second image forming apparatuses among the plurality of image forming apparatuses included as a unit of execution of the print processing; and
notifying the generated notification information.

6. A computer readable storage medium on which is stored a computer program for making a computer execute a method for monitoring a plurality of image forming apparatuses, the method comprising:
associating and managing, a plurality of image forming apparatuses as a unit of execution for print processing;
receiving first failure information regarding failure occurred in a first image forming apparatuses among any one of the plurality of image forming apparatuses included as a unit of execution of the print processing via a network;
generating notification information indicating addressing processing for the failure occurred in the plurality of image forming apparatuses included as a unit of execution of the print processing based on the positional relationship among the plurality of image forming apparatuses and types of the failures indicated by the received first failure information and second failure information when the second failure information has been received from one or more second image forming apparatuses among the plurality of image forming apparatuses included as a unit of execution of the print processing; and
notifying the generated notification information.

7. A management system comprising:
an image forming apparatus that executes print processing; and
a management apparatus that manages the image forming apparatus,
wherein the image forming apparatus comprises:
a transmission unit configured to transmit failure information regarding the occurred failure to the management apparatus when failure has occurred on the image forming apparatus,
wherein the management apparatus comprises:
an association unit configured to associate and manage a plurality of image forming apparatuses as a unit of execution for print processing;
a reception unit configured to receive first failure information regarding failure occurred in a first image forming apparatuses among any one of the plurality of image forming apparatuses included as a unit of execution of the print processing via a network;
a generation unit configured to generate notification information indicating addressing processing for the failure occurred in the plurality of image forming apparatuses included as a unit of execution of the print processing based on the positional relationship among the plurality of image forming apparatuses and types of the failures indicated by the received first failure information and second failure information when the second failure information has been received from one or more second image forming apparatuses among the plurality of image forming apparatuses included as a unit of execution of the print processing; and
a notification unit configured to notify the generated notification information.

8. A management method performed by a management system comprising an image forming apparatus that executes print processing and a management apparatus that manages the image forming apparatus, the management method comprising:
transmitting failure information by the image forming apparatus regarding the occurred failure to the management apparatus when failure has occurred on the image forming apparatus;
associating and managing a plurality of image forming apparatuses as a unit of execution for print processing by the management apparatus;
receiving failure information by the management apparatus regarding first failure information regarding failure occurred in a first image forming apparatuses among any one of the plurality of image forming apparatuses included as a unit of execution of the print processing via a network;
generating notification information by the management apparatus in which the notification information indicates addressing processing for the failure occurred in the plurality of image forming apparatuses included as a unit of execution of the print processing based on the positional relationship among the plurality of image forming apparatuses and types of the failures indicated by the received first failure information and second failure information when the second failure information has been received from one or more second image forming apparatuses among the plurality of image forming apparatuses included as a unit of execution of the print processing; and
notifying the generated notification information by the management apparatus.
